(19) United States
(12) Patent Application Publication
(10) Pub. No.: US 2016/0055007 A1
(43) Pub. Date: Feb. 25, 2016

(54) INFORMATION PROCESSING APPARATUS AND SETTING METHOD FOR INFORMATION PROCESSING APPARATUS

(71) Applicant: FUJITSU LIMITED, Kawasaki-shi (JP)

(72) Inventor: Koji TORIYAMA, Yokosuka (JP)

(21) Appl. No.: 14/820,589

(22) Filed: Aug. 7, 2015

(30) Foreign Application Priority Data
Aug. 22, 2014 (JP) 2014-169078

(51) Int. Cl. G06F 9/44; G06F 9/445

(52) U.S. Cl. CPC G06F 9/4403; G06F 9/44505

(57) ABSTRACT

An information processing apparatus includes a control device. The control device includes a storage device including a first storage field to store a procedure for a control process of the information processing apparatus and a second storage field to store a procedure for a setting process corresponding to a user of the information processing apparatus, a memory storing a boot flag to specify whether the setting process is to be executed, and a processor configured to set the boot flag so as to restrain the execution of the setting process after executing the setting process.

### CROSS-REFERENCE TO RELATED APPLICATION

This application is based upon and claims the benefit of priority of the prior Japanese Patent Application No. 2014-169078, filed on Aug. 22, 2014, the entire contents of which are incorporated herein by reference.

### FIELD

The embodiments discussed herein are related to an information processing apparatus and a setting method for an information processing apparatus.

### BACKGROUND

A variety of hardware settings related to building up a computer system are changed corresponding to system settings unique to a user when introducing the computer system. The settings to be changed are, e.g., a Basic Input/Output System (BIOS) setting, a Baseboard Management Controller (BMC) firmware setting, a Redundant Arrays of Independent Disks (RAID) system setting. A BMC is a system management controller to monitor system statuses as instanced by monitoring a voltage error, a temperature error and other equivalent errors, notifying of error information, controlling a power source and other equivalent control unique to a system.

These hardware settings can be manually changed by use of input interfaces instanced by a mouse or a keyboard and other equivalent interfaces in accordance with building up the computer system after operating the computer system.

[Patent document 1] Japanese Laid-Open Patent Publication No. H08-161160
[Patent document 2] Japanese Laid-Open Patent Publication No. 2005-316858
[Patent document 3] Japanese Laid-Open Patent Publication No. 2010-224847

### SUMMARY

An aspect of the embodiments is exemplified by an information processing apparatus. The information processing apparatus includes a control device. The control device includes a storage device including a first storage field to store a procedure for a control process of the information processing apparatus and a second storage field to store a procedure for a setting process corresponding to a user of the information processing apparatus, a memory storing a boot flag to specify whether the setting process is to be executed, and a processor configured to set the boot flag so as to restrain the execution of the setting process after executing the setting process.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is a diagram illustrating one example of an apparatus configuration of a computer system in a comparative example;

FIG. 2 is a diagram illustrating one example of BMC firmware including a BMC basic field to which customization setting processes are added;

FIG. 3 is a diagram illustrating one example of the BMC firmware including a customization field to which the customization setting processes are added;

FIG. 4 is a diagram illustrating a flowchart of the customization setting processes automated by the BMC firmware;

FIG. 5 is a diagram illustrating an example of the customization field being overwritten to the BMC basic field;

FIG. 6 is a diagram illustrating one example of an apparatus configuration of an information processing apparatus;

FIG. 7 is a diagram illustrating one example of a processing configuration of the information processing apparatus according to a first embodiment;

FIG. 8 is a diagram illustrating one example of a BMC firmware storage unit including a customization field configured independently;

FIG. 9 is a diagram illustrating one example of a BMC setting table;

FIG. 10 is a diagram illustrating one example of a flowchart of the customization setting process by the BMC firmware;

FIG. 11 is a diagram illustrating one example of a BMC firmware storage unit and a BMC setting table before implementing the customization settings;

FIG. 12 is a diagram illustrating one example of the BMC setting table after implementing the customization settings;

FIG. 13 is a diagram illustrating one example of the BMC firmware storage unit and the BMC setting table when rebooting the information processing apparatus after implementing the customization settings;

FIG. 14 is a diagram illustrating one example of a processing configuration of the information processing apparatus in a second embodiment;

FIG. 15 is a diagram illustrating one example of a flowchart of writing processes to a boot field and a customization field;

FIG. 16 is a diagram illustrating one example of customization setting firmware;

FIG. 17 is a diagram illustrating one example of the BMC firmware storage unit after writing to the boot field;

FIG. 18 is a diagram illustrating one example of the BMC firmware storage unit and the BMC setting table after executing a boot process;

FIG. 19 is a diagram illustrating one example of the BMC firmware storage unit and the BMC setting table after writing to the customization field; and

FIG. 20 is a diagram illustrating one example of the BMC setting table after writing to the customization field and updating a boot flag.

### DESCRIPTION OF EMBODIMENTS

Manual inputs of hardware settings using the input interface take time, the hardware settings corresponding to users related to building up the computer system. This is because the hardware settings are inputted while checking an operation design of the computer system after booting the computer system. The manual setting inputs using the input interface after booting the computer system take several tens of minutes per system. Supposing that the time for setting one computer system is, e.g., 30 minutes, it is therefore estimated that the time for setting the 1000 computer systems at a data center reaches 500 hours when building up the 1000 computer systems at the data center. Consequently, such a problem arises that it is difficult to ensure manpower for performing the setting inputs when building up the systems.

It is considered to automate the inputs of the hardware settings by use of the BMC that operates simultaneously when switching ON a power source of the computer system. Specifically, BMC firmware as a program for controlling the BMC additionally implements processes of the hardware settings corresponding to users (which will hereinafter be also termed customization settings), whereby the hardware settings are automatically changed. However, a BMC basic function for the BMC to monitor the system statuses includes processes unique to the computer system. Therefore, when performing the customization settings by using the BMC, the BMC firmware is developed per computer system. It takes a certain amount of time for developing and evaluating the BMC firmware per computer system.

An embodiment of the present invention will hereinafter be described based on the drawings. A configuration of the following embodiment is an exemplification, and the present invention is not limited to the configuration of the embodiment.

### Comparative Example

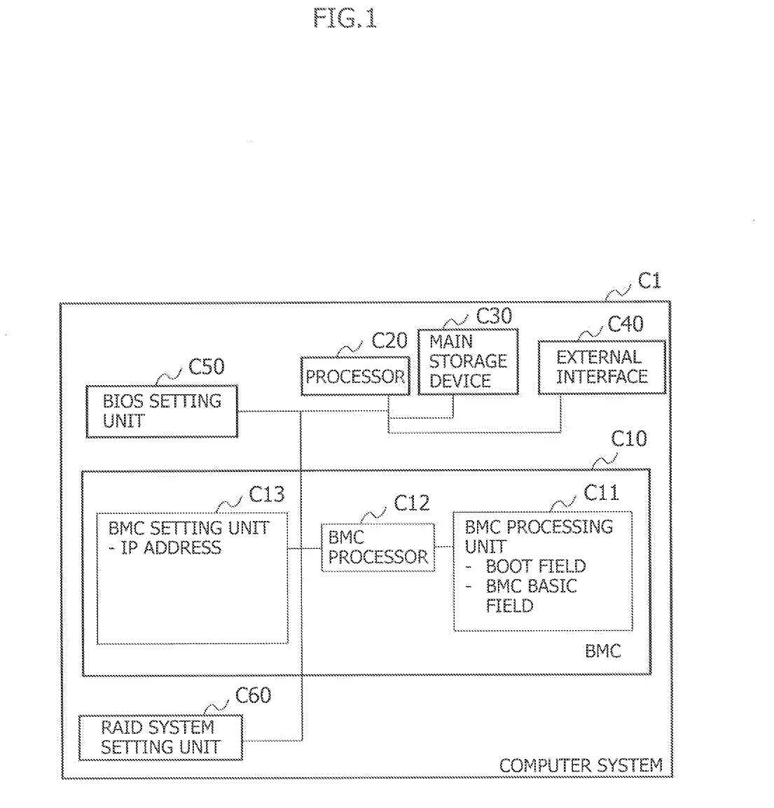

FIGS. 1 through 5 are explanatory diagrams of automated processes for customization settings in a comparative example. FIG. 1 is the diagram illustrating one example of an apparatus configuration of a computer system in the comparative example. The computer system includes a BMC C10, a processor C20, a main storage device C30, an external interface C40, a BIOS setting unit C13, and a RAID system setting unit C60. The BMC C10 includes a BMC processing unit C11, a BMC processor C12, and a BMC setting unit C13. The BMC processing unit C11 stores BMC firmware defined as software for controlling the BMC. The BMC processor C12 is a processor for executing the BMC firmware. The BMC setting unit C13 is a nonvolatile memory to store an Internet Protocol (IP) address and other equivalent data of the BMC.

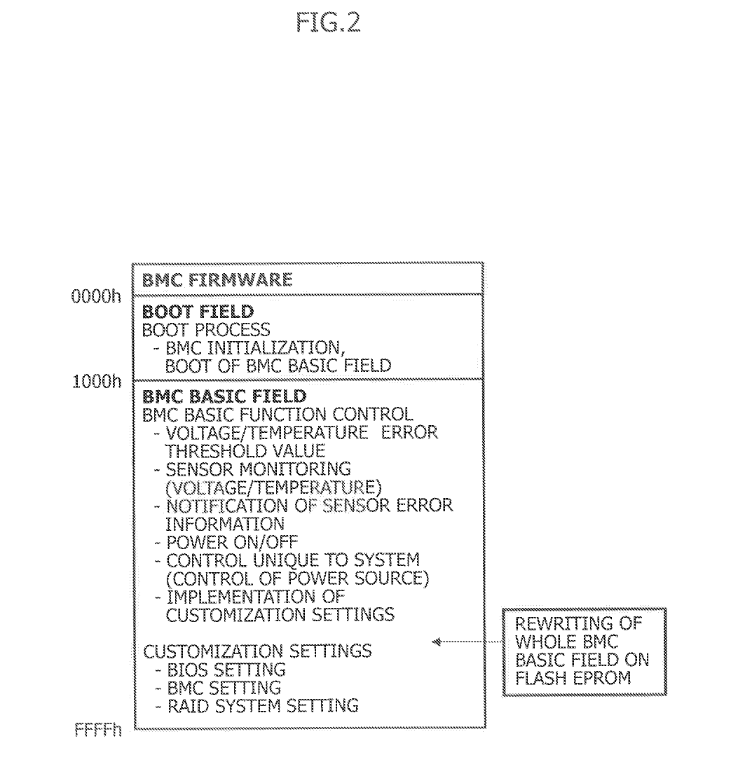

FIG. 2 is a diagram illustrating one example of the BMC firmware including a BMC basic field to which customization setting processes are added. The BMC firmware is written to, e.g., a Flash Erasable Programmable Read Only Memory (Flash EPROM). The BMC firmware includes a boot field and the BMC basic field in FIG. 2.

The boot field written to addresses “0000h” through “1000h” contains a boot process instanced by initializing the BMC and booting the BMC basic field. The BMC basic field written to addresses “1000h” through “FFFFh” contains processes related to BMC basic function control and customization settings.

The BMC basic function control is control instanced by system board management and other equivalent control over functions unique to the computer system. The BMC basic function control includes processes of setting a threshold value for a voltage error and a threshold value for a temperature error, monitoring a voltage sensor, a temperature sensor and other equivalent sensors, notifying of sensor error information, switching ON/OFF a power source, controlling the power source, and other equivalent processes.

The customization setting is a hardware setting independent on a type and other equivalent attribute information of the computer system. The customization setting includes processes instanced by a BIOS setting, a BMC setting, a RAID system setting and other equivalent settings.

The BMC basic field is configured to rewrite the whole BMC basic field by adding the customization setting processes to the BMC basic function control process in FIG. 2. The BMC basic function control process has an addition of a process of invoking the customization setting processes, thereby automating the customization setting processes.

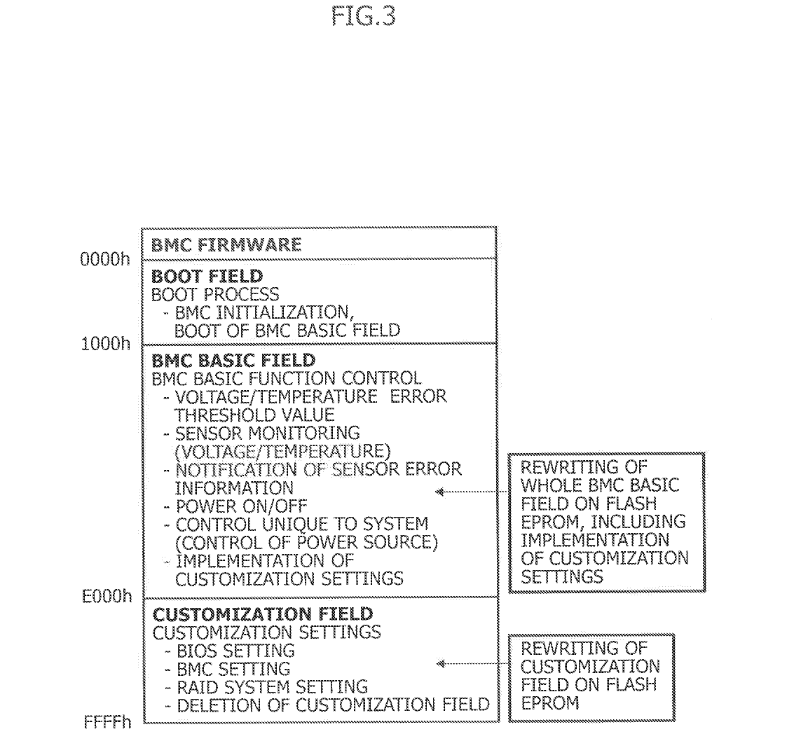

FIG. 3 is a diagram illustrating one example of the BMC firmware including the customization field, separated from the BMC basic field, to which the customization setting processes are added. The BMC firmware includes the boot field, the BMC basic field, and the customization field in FIG. 3.

The boot field is the same as in FIG. 2, and hence the description thereof is omitted. The BMC basic field written to addresses “1000” through “E000h” contains processes related to the basic function control. Contents of the processes related to the BMC basic function control are the same as in FIG. 2. The customization field written to addresses “E000h” through “FFFFh” contains processes related to the customization settings. Contents of the processes related to the customization settings are the same as in FIG. 2.

The BMC basic field is configured to rewrite the whole BMC basic field by adding a process of invoking the customization setting processes to the BMC basic function control process in FIG. 3. The customization field contains processes for the customization settings, and is written to the field separated from the BMC basic field. The customization settings are automated by invoking the customization setting processes from the BMC basic function control process.

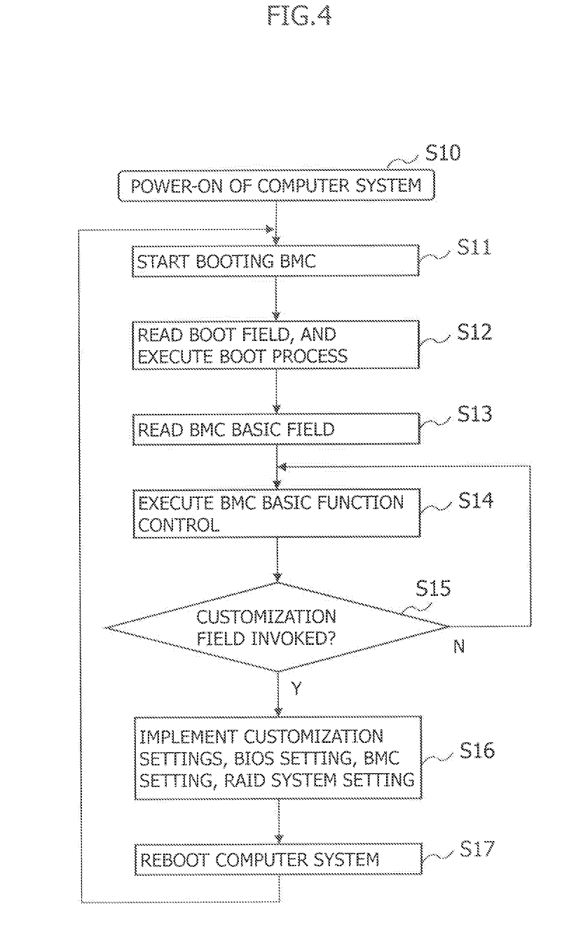

FIG. 4 is a diagram illustrating a flowchart of the customization setting processes automated by the BMC firmware. A start of the processes in FIG. 4 is triggered by switching ON the power source of the computer system in S10. The BMC firmware is executed by the BMC processor.

Upon starting the processes in FIG. 4, the BMC processor shifts the processing to S11. The BMC processor starts booting the BMC in S11, and shifts the processing to S12. The BMC processor reads the boot field and executes a boot process instanced by initializing the BMC, starting up the BMC basic field and other equivalent processing in S12, and shifts the processing to S13.

The BMC processor reads the BMC basic field in S13, and shifts the processing to S14. The BMC processor executes the BMC basic function control in S14, and shifts the processing to S15. The BMC processor determines in S15 whether the customization settings are invoked or not. The BMC processor shifts the processing to S16 when invoked but loops back the processing to S14 whereas when not invoked.

The BMC processor executes the customization setting processes in S16. To be specific, the BMC processor executes the customization setting processes instanced by implementing the BIOS setting, the BMC setting, the RAID system setting and other equivalent settings, and shifts the processing to S17. The BMC processor reboots the computer system in S17, and loops back the processing to S11.

The automation of the customization settings can be, as described in FIG. 2, attained by including the customization settings in the BMC basic field. On the other hand, it follows that the whole BMC basic field including the BMC basic function control process in the BMC firmware is developed and evaluated per computer system. An increased number of development steps and an increased number of evaluation steps are therefore carried out for attaining the automation of the customization settings.

The automation of the customization settings can be also, as described in FIG. 3, attained by including the customization settings in the customization field separate from the BMC basic field. In this case, the customization field can be managed separately from the BMC basic field. However, the following problems arise.

(1) On the occasion of separating the customization settings to the customization field, the process of invoking the customization settings is added to within the BMC basic field. The BMC firmware is therefore developed to include the function control within the BMC basic field, the function control being unique to the computer system. In other words, it follows that the BMC firmware is developed per computer system. Accordingly, when automating the hardware settings of the computer system at a data center and other equivalent facilities introducing a plurality of computer systems, there is an increased number of pieces of BMC firmware to be developed.

(2) The automation of the customization settings is attained by the development and the evaluation of the customization field. The process of invoking the customization settings is contained in the BMC basic field. It therefore follows that the developments and the evaluations of not only the customization field but also the BMC basic field are implemented. Hence, there are an increased number of development steps and an increased number of evaluation steps of the BMC firmware.

(3) When the customization field is written afterward, there is a possibility that the already written BMC basic field is to be overwritten and the processes in the BMC basic field are to be affected.

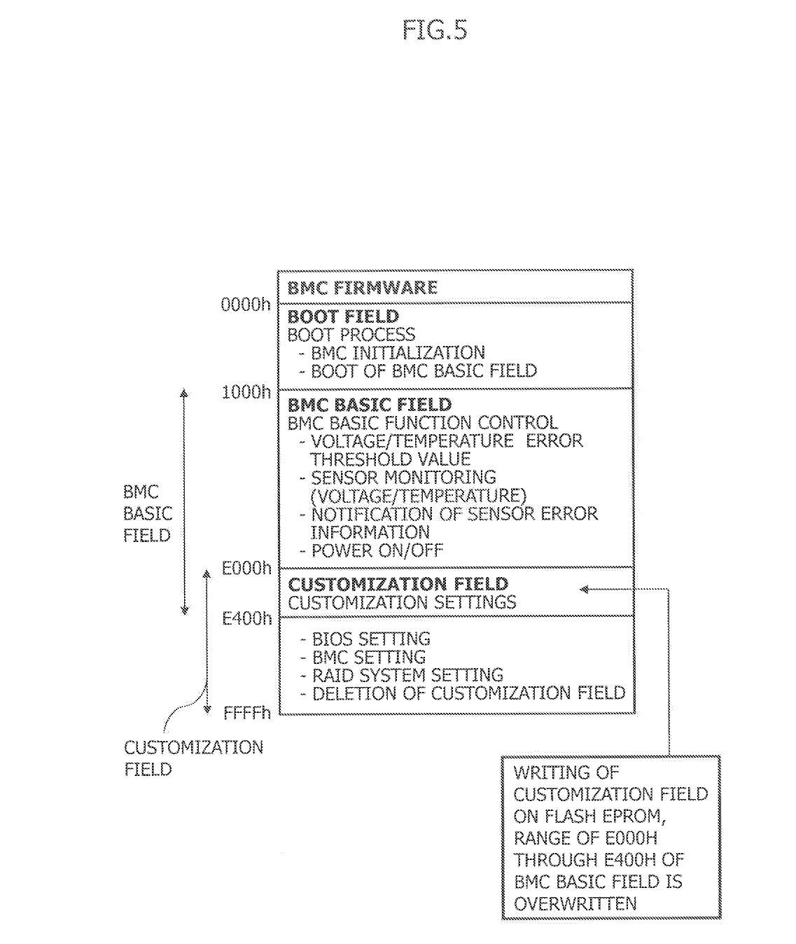

FIG. 5 illustrates the problem (3). FIG. 5 is a diagram illustrating an example of the customization field being overwritten to the BMC basic field. The BMC firmware includes the boot field, the BMC basic field and the customization field in FIG. 5.

The boot field is the same as in FIG. 2. The BMC basic field is written to addresses “1000h” through “E400h”, and contains processes related to the BMC basic function control. The BMC basic function control is the same as in FIG. 2. The customization field is written to addresses “E000h” through “FFFFh”, and contains processes related to the customization settings. The customization settings are the same as in FIG. 2.

The customization field is written from the address “E000h” being smaller than the last address “E400h” of the BMC basic field which has been written. A range delimited by the addresses “E000h” through “E400h” of the BMC basic field is overwritten by the customization field, resulting in the possibility that the processes within the overwritten range are to be affected.

### First Embodiment

A first embodiment is an exemplification that the information processing apparatus executes the customization setting processes independently without affecting the BMC basic function control process within the BMC basic field. The first embodiment implements the customization setting processes in a field separated from the BMC basic field. The customization setting processes are invoked not from the BMC basic field but from the boot field.

The customization setting processes are therefore executed independently of the BMC basic function control process in the BMC basic field. In other words, the customization setting processes can function without changing the BMC basic function control dependent upon a type of the computer system. The firmware of the customization setting processes corresponding to users can be developed and implemented without containing the processes unique to the computer system.

<Apparatus Configuration>

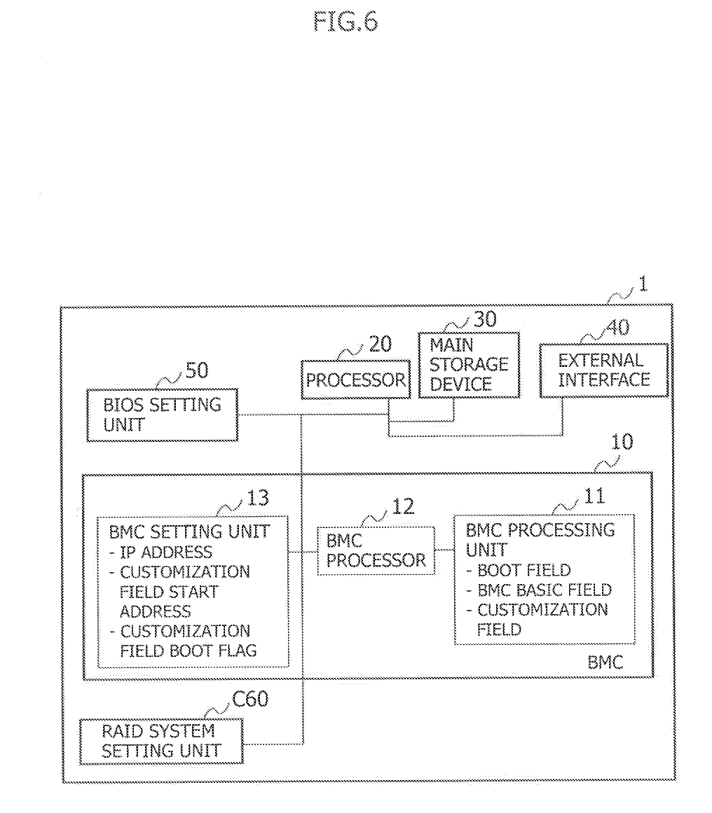

FIG. 6 is a diagram illustrating one example of an apparatus configuration of an information processing apparatus 1. The information processing apparatus 1 includes a BMC 10, a processor 20, a main storage device 30, an external interface 40, a BIOS setting unit 50, and a RAID system setting unit 60. Note that a specific apparatus configuration of the information processing apparatus 1 is not limited to the configuration illustrated in FIG. 6 but may be properly modified as instanced by addition, replacement, deletion and other equivalent modifications.

The BMC 10 is a system management controller performing control unique to the system as instanced by monitoring a voltage error, a temperature error and other equivalent errors, notifying of error information, controlling the power source and other equivalent control. The BMC 10 includes a BMC processing unit 11, a BMC processor 12, and a BMC setting unit 13. The BMC 10 is one example of a control device.

The BMC processing unit 11 stores the BMC firmware. The BMC firmware can be written separately with pieces of firmware of the boot field, the BMC basic field, the customization field, and other equivalent fields, to which pieces of firmware can be written. The BMC processing unit 11 is, e.g., a semiconductor memory instanced by Flash EPROM and other equivalent memories.

The BMC processor 12 executes the BMC firmware stored in the BMC processing unit 11, thereby providing functions of the BMC basic function control and the customization settings. The BMC processor 12 is a processor enabled to execute the processes independently of the processor 20. The BMC processor 12 has interfaces with respective pieces of hardware, and can make settings for the respective pieces of hardware.

The BMC setting unit 13 stores a start address of the customization field used for executing the BMC firmware stored in the BMC processing unit 11, a customization field boot flag, and other equivalent items. The BMC setting unit 13 is a nonvolatile memory instanced by an Electrically Erasable Programmable Read-Only Memory (EEPROM) and other equivalent memories.

The processor 20 executes a computer program deployed in an executable manner on the main storage device 30. A part of processes by the computer program may, however, be executed by a hardware circuit. The processor 20 is exemplified by a Central Processing Unit (CPU) and a Digital Signal Processor (DSP).

The main storage device 30 provides the processor 20 with a storage area for loading the computer program and an operation area for executing the computer program. The main storage device 30 is also used as a buffer for temporarily retaining data. The main storage device 30 is a semiconductor memory exemplified by a Random Access Memory (RAM).

The external interface 40 is an interface for acquiring the BMC firmware for the BMC processing unit 11 from outside. The external interface 40 may be a Local Area Network (LAN) interface. The external interface 40 is exemplified by a Network Interface Card (NIC) and a wireless LAN card. The external interface 40 acquires the BMC firmware from a network to be connected, and stores the BMC firmware in the BMC processing unit 11. The external interface 40 may also be an Input/Output device for a portable medium. The external interface 40 is exemplified by an Input/Output device for the flash memory card, a USB adaptor for connecting a Universal Serial Bus (USB) memory, a drive for a disc medium instanced by a Compact Disc (CD) and other equivalent discs. The external interface 40 reads the BMC firmware from the portable medium, and stores the BMC firmware in the BMC processing unit 11.

The BIOS setting unit 50 stores setting information for controlling peripheral devices of the information processing apparatus 1. The BIOS setting unit 50 is a nonvolatile memory instanced by a Complementary Metal Oxide Semiconductor (CMOS), an EEPROM and other equivalent memories. The RAID system setting unit 60 stores setting information for building up and managing the RAID system. The RAID system setting unit 60 is a nonvolatile memory instanced by the EEPROM and other equivalent memories.

<Processing Configuration>

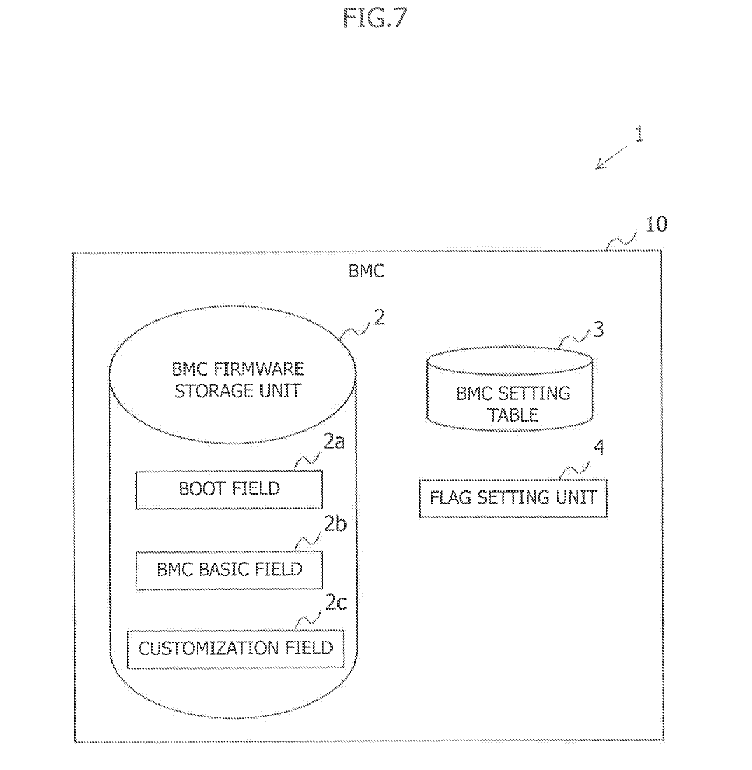

FIGS. 7 through 9 are explanatory diagrams of an example of a processing configuration of the information processing apparatus 1. FIG. 7 is the diagram illustrating one example of the processing configuration of the information processing apparatus 1 according to the first embodiment. The information processing apparatus 1 include the BMC 10. The BMC 10 includes, as the processing configuration, a BMC firmware storage unit 2, a BMC setting table 3, and a flag setting unit 4. The BMC processor 12 executes, based on the computer program, the process of the flag setting unit 4. The hardware circuit may also execute the process of the flag setting unit 4.

The BMC firmware storage unit 2 is a storage device for storing the firmware to execute the process of the BMC. The BMC firmware storage unit 2 includes a boot field 2a, a BMC basic field 2b and a customization field 2c. The BMC firmware storage unit 2 is exemplified by the Flash EPROM.

The boot field 2a stores the firmware to execute a process when booting the BMC. The BMC basic field 2b stores the firmware to execute the BMC basic function control process unique to the computer system corresponding to the type of the information processing apparatus 1. The customization field 2c stores the firmware to execute a variety of hardware settings corresponding to the users.

The respective pieces of firmware can be written to the BMC firmware storage unit 2 by reading a program for writing the firmware from the external interface 40 and executing the readout program. The BMC firmware storage unit 2 can be written with each piece of firmware of the boot field 2a, the BMC basic field 2b and the customization field 2c on a field-by-field basis.

The BMC firmware storage unit 2 is one example of a storage device. The boot field 2a is one example of a third storage unit. The BMC basic field 2b is one example of a first storage unit. The customization field 2c is one example of a second storage unit.

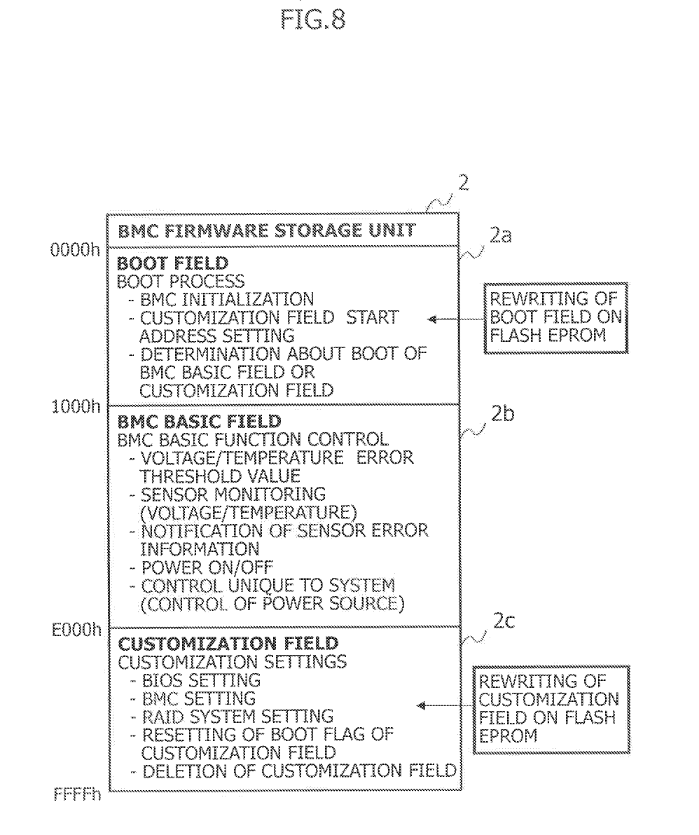

FIG. 8 is a diagram illustrating one example of the BMC firmware storage unit 2 including the customization field configured independently. Herein, the boot field 2a, the BMC basic field 2b and the customization field 2c illustrated in FIG. 8 describe the processes to be executed in the respective fields, but it does not mean that these fields are described in an execution format of the BMC processor 12.

The boot field 2a is written to a range of addresses “0000h”-“1000h” in FIG. 8. The boot field 2a stores, e.g., a BMC initialization process, a customization field start address setting process, and a boot determination process of the BMC basic field 2b or the customization field 2c.

The BMC basic field 2b is written to a range of addresses “1000h”-“E000h” in FIG. 8. The BMC basic field 2b stores, e.g., a voltage/temperature error threshold value management process, a process of monitoring a voltage sensor, a temperature sensor and other equivalent sensors, a sensor error information notifying process, and a process of switching ON/OFF the power source.

The customization field 2c is written to a range of addresses “E000h”-“FFFFh” in FIG. 8. The customization field 2c stores, e.g., a BIOS setting process, a BMC setting process, a RAID system setting process, a process of resetting the customization field boot flag, and a process of deleting the customization field.

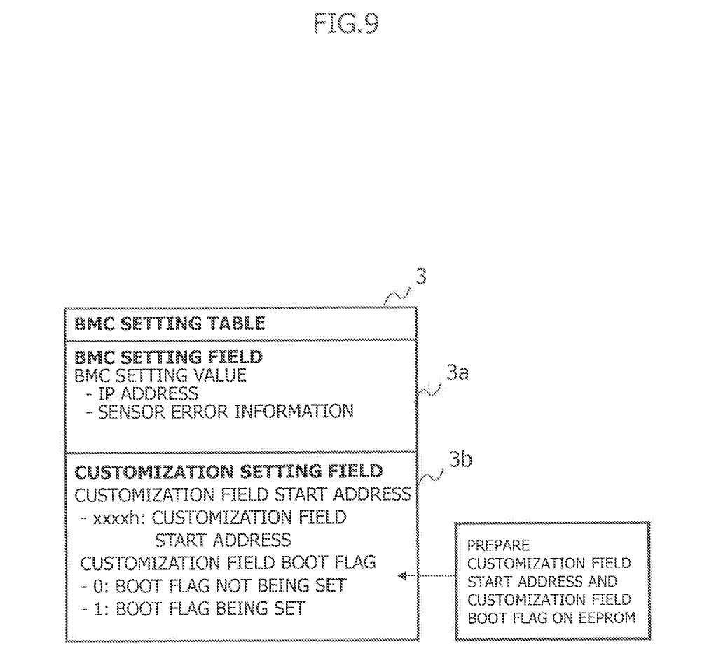

The BMC setting table 3 stores setting values used for the processes stored in the BMC firmware storage unit 2. FIG. 9 is a diagram illustrating one example of the BMC setting table 3. Herein, the BMC setting table 3 depicted in FIG. 9 describes the setting values stored in the BMC setting table 3, but it does not mean that these setting values are described in a format used for the processing by the BMC processor 12. The BMC setting table 3 is one example of a storage unit.

The BMC setting table 3 contains a BMC setting field 3a and a customization setting field 3b in FIG. 9. The BMC setting field 3a stores, e.g., an IP address of the information processing apparatus 1 and sensor error information.

The customization setting field 3b stores, e.g., a customization field start address and a customization field boot flag. The customization field start address represents a start address of the customization field to which the customization setting process is written. The customization field boot flag (which will hereinafter be simply termed a boot flag) is a flag for determining whether the customization field is booted. It can be determined that, for example, the BMC processor 12 does not boot the customization field when a value of the boot flag is “0”, but boots the customization field when the value of the boot flag is “1”.

The flag setting unit 4 changes the setting of the boot flag in the BMC setting table 3. The BMC processor 12 determines based on the value of the boot flag whether the customization field is booted.

<Processing Flow>

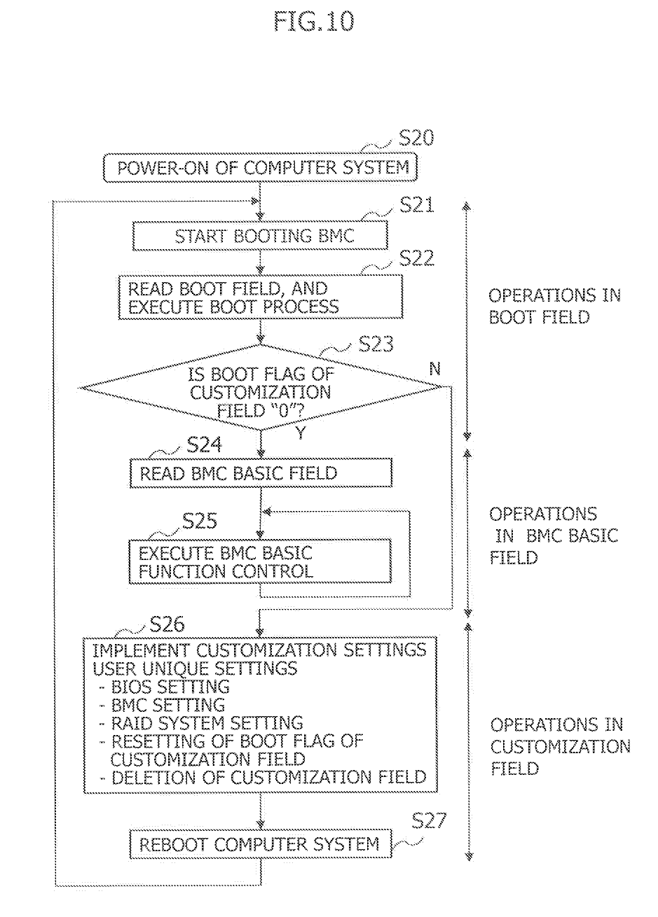

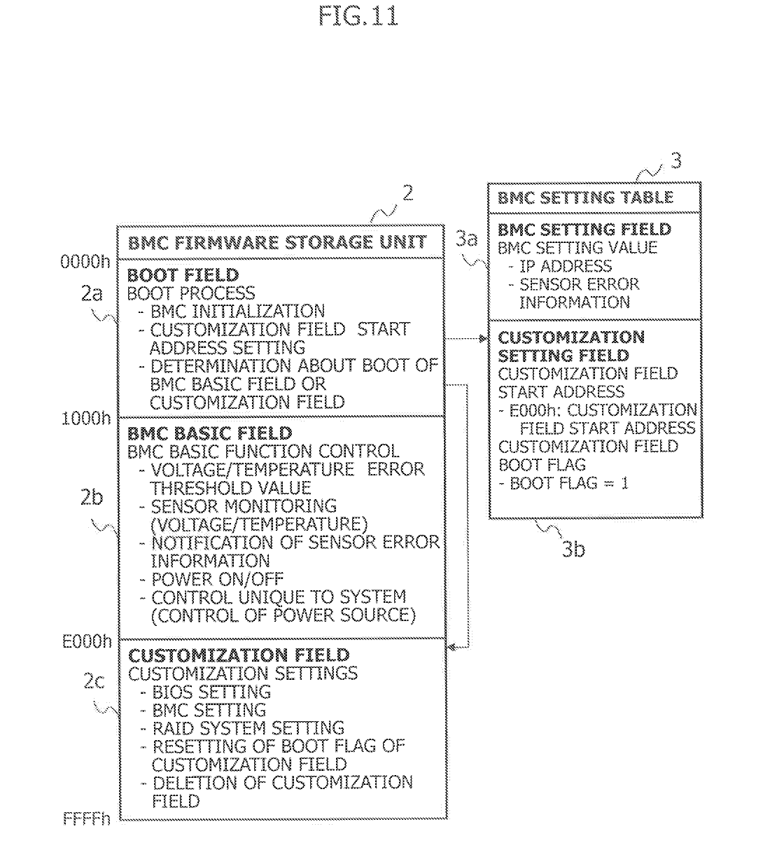

FIGS. 10-13 are an explanatory flowchart and explanatory diagrams of a processing flow in the first embodiment. FIG. 10 is one example of a flowchart of the customization setting process by the BMC firmware. FIGS. 11-13 illustrate the BMC firmware storage unit 2 and the BMC setting table 3 to be changed corresponding to the respective processes in the flowchart of FIG. 10.

FIG. 11 is the diagram illustrating one example of the BMC firmware storage unit 2 and the BMC setting table 3 before implementing the customization settings. In other words, FIG. 11 illustrates the BMC firmware storage unit 2 and the BMC setting table 3 before executing the processes in FIG. 10.

The BMC firmware storage unit 2 in FIG. 11 is the same as in FIG. 8, and hence the description thereof is omitted. The BMC setting field 3a in the BMC setting table 3 in FIG. 11 is the same as in FIG. 9, and its description is therefore omitted. A value “E000h” is set as the customization field start address in the customization setting field 3b of FIG. 11. A value “1” is set in the boot flag.

A start of the processes in FIG. 10 is triggered by the power-ON of the information processing apparatus 1 (the computer system) in S20 after the firmware has been written to the boot field 2a and the customization field 2c.

The BMC processor 12 starts up the BMC in S21, and shifts the processing to S22. The BMC processor 12 reads the boot field 2a and executes the boot process in S22. The boot process contains the BMC initialization process, the customization field start address setting process, and the boot determination process of the BMC basic field 2b or the customization field 2c. Note that the BMC processor 12 may not execute the customization field start address setting process because of the firmware being already written to the customization field 2c. Next, the BMC processor 12 shifts the processing to S23.

The BMC processor 12 determines in S23 whether the boot flag is “0” or not. The BMC processor 12 shifts the processing to S24 when the boot flag is “0” (S23: Y), but diverts the processing to S26 whereas when the boot flag is “1” (S23: N). The processes in S21 through S23 are categorized as operations in the boot field 2a. The process in S23 is one example of determining a boot flag to specify whether the setting process is to be executed.

In S24, the BMC processor 12 reads the BMC basic field 2b and shifts the processing to S25. The BMC processor 12 implements the BMC basic function control instanced by monitoring the sensor, notifying of the sensor error information, and other equivalent control in S25. The BMC processor 12 continues the operation of the BMC basic function control. The processes in S24 and S25 are categorized as operations in the BMC basic field 2b. The processes in S24 and S25 are one example of executing a procedure for a control process of the information processing apparatus.

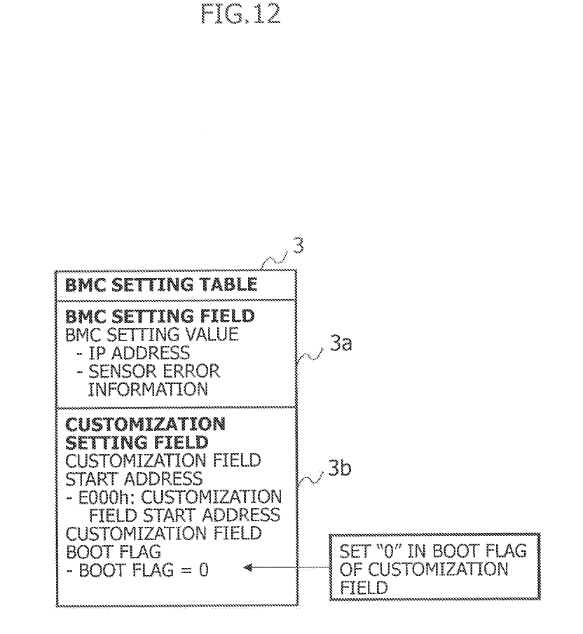

The BMC processor 12 implements the customization settings in S26. The customization settings contain, e.g., the BIOS setting process, the BMC setting process, and the RAID system setting process. The BMC processor 12 resets the customization field boot flag. To be specific, the BMC processor 12 sets “0” in the boot flag. FIG. 12 is a diagram illustrating one example of the BMC setting table 3 after implementing the customization settings. In FIG. 12, “0” is set in the boot flag. Further, the BMC processor 12 deletes the customization field 2c. The process in S26 is categorized as operations in the customization field 2c. The process in S26 is one example of executing a procedure for a setting process corresponding to a user of the information processing apparatus. Subsequently, the BMC processor 12 shifts the processing to S27.

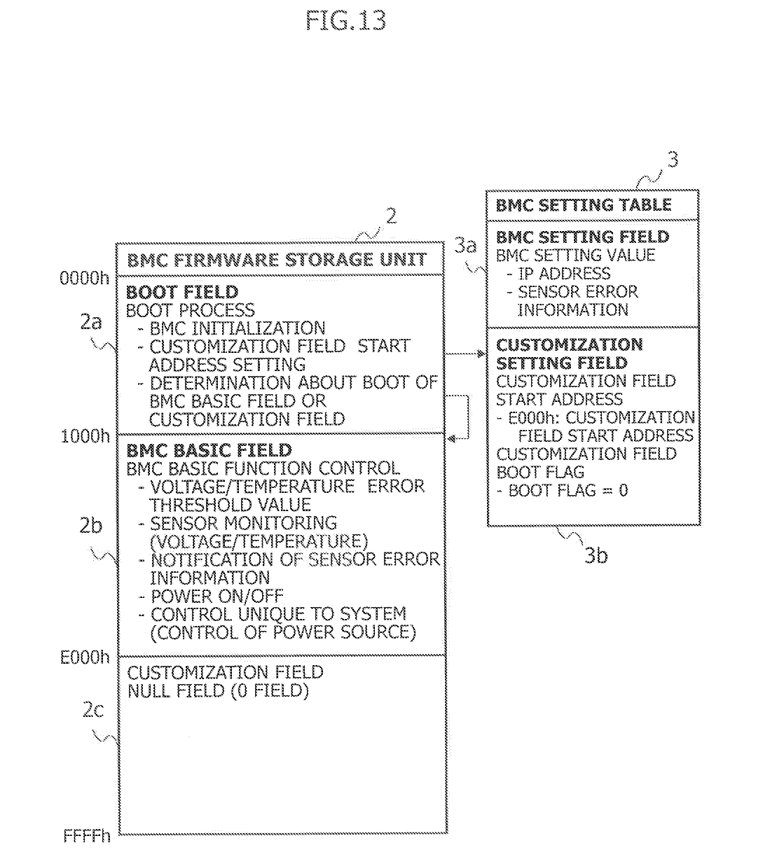

The BMC processor 12 reboots the information processing apparatus 1 in S27. FIG. 13 is a diagram illustrating one example of the BMC firmware storage unit 2 and the BMC setting table 3 when rebooting the information processing apparatus 1 after implementing the customization settings in S26.

The boot field 2a and the BMC basic field 2b of the BMC firmware storage unit 2 in FIG. 13 are the same as in FIG. 8, and hence the descriptions thereof are omitted. In FIG. 13, the customization field 2c of the BMC firmware storage unit 2 is deleted in S26 to become a null field.

The BMC setting field 3a of the BMC setting table 3 is the same as in FIG. 9, and the description thereof is therefore omitted. A value “E000h” is set as the customization field start address in the customization setting field 3b in FIG. 13. A value “0” is set in the boot flag in the process of S26. The processes in S26 and S27 are categorized as operations in the customization field 2c. Subsequently, the BMC processor 12 loops back the processing to S21. The BMC processor 12 continues the operation for the BMC basic function control after rebooting.

<Operational Effect of First Embodiment>

The information processing apparatus 1 in the first embodiment boots the customization settings stored in the customization field 2c from the boot field 2a of the BMC firmware storage unit 2. Specifically, a value for booting the customization field 2c is set in the boot flag, whereby the information processing apparatus 1 automates the customization settings. This automation therefore reduces man-hour for the customization settings performed manually via an input interface instanced by a mouse or a keyboard and other equivalent interfaces.

The BMC basic function control process stored in the BMC basic field 2b of the BMC firmware storage unit 2 is a process unique to the computer system corresponding to the type of the information processing apparatus 1. The information processing apparatus 1 in the first embodiment implements the customization settings independently of the BMC basic function control. The customization settings can be therefore individually developed without including the processes unique to the computer system. Accordingly, the BMC firmware including the customization setting processes does not have to be prepared per computer system, and the number of pieces of BMC firmware to be developed is reduced.

The information processing apparatus 1 implements the customization settings independently of the BMC basic function control. The firmware including the customization setting processes can be therefore individually developed and evaluated without including the BMC basic function control. Accordingly, the development and the evaluation of the whole BMC firmware inclusive of the BMC basic function control can be simplified, resulting in reducing man-hour for developing and evaluating the BMC firmware.

### Second Embodiment

A second embodiment is an exemplification that the information processing apparatus 1 implements the customization settings in the same way as in the first embodiment after writing the customization field 2c in a storage location separated from a storage location of the BMC basic field 2b. The information processing apparatus 1 in the second embodiment acquires the storage location of the BMC basic field 2b. The customization field 2c is written to the storage location separated from the storage location of the BMC basic field 2b. The BMC basic field 2b is not therefore affected by the write to the customization field 2c. The customization field 2c can be consequently written to the active computer system. The apparatus configuration in the second embodiment is the same as in the first embodiment, and hence the description thereof is omitted.

<Processing Configuration>

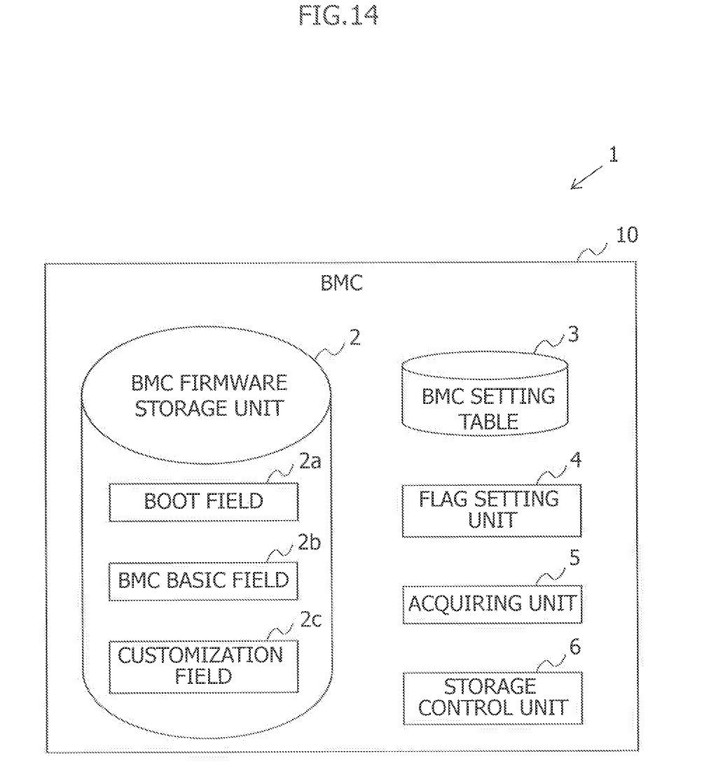

FIG. 14 is a diagram illustrating one example of a processing configuration of the information processing apparatus 1 in the second embodiment. The information processing apparatus 1 in the second embodiment has the BMC 10 that includes, as the processing configuration, an acquiring unit 5 and a storage control unit 6 in addition to the processing configuration in the first embodiment.

The BMC processor 12 executes, based on the computer program, processes of the acquiring unit 5 and the storage control unit 6. The hardware circuit may execute any one of the acquiring unit 5 and the storage control unit 6 or a part of the processes thereof. The description of the same processing configuration as in the first embodiment is omitted.

The acquiring unit 5 acquires a start address of the customization field 2c. It may be sufficient that the BMC processor 12 can write the customization field 2c separately from the storage location of the BMC basic field 2b. Accordingly, the acquiring unit 5 acquires, e.g., the last address of the BMC basic field 2b as the start address of the customization field 2c.

The acquiring unit 5 sets the acquired last address value as a customization field start address of the customization setting field 3b in the BMC setting table 3. The acquired last address value being set as the start address, the BMC processor 12 is enabled to write the customization field 2c separately from the BMC basic field 2b.

Note that the acquiring unit 5 can acquire, based on, e.g., a search algorithm given below, the last address value of the BMC basic field 2b. The acquiring unit 5 makes a forward search for a 0-bit string field from the last address of the BMC firmware storage unit 2 on a capacity unit instanced by 16 KB or 32 KB and other equivalent capacities, corresponding to characteristics of the memory. The acquiring unit 5 can set a last address of a non 0-bit field being detected for the first time as the last address value of the BMC basic field 2b.

A method of acquiring the last address value of the BMC basic field 2b is not limited to the search algorithm. The acquiring unit 5 may also acquire the last address value of the BMC basic field 2b by use of a more complicated search algorithm than the foregoing search algorithm. The customization field start address or the last address value of the BMC basic field 2b is one example of a storage location of a first storage unit.

The storage control unit 6 controls writing to the customization field 2c. The storage control unit 6 acquires the customization field start address stored by the acquiring unit 5 in the BMC setting table 3. The storage control unit 6 writes the customization field 2c in the acquired customization field start address separately from the storage location of the BMC basic field 2b.

<Processing Flow>

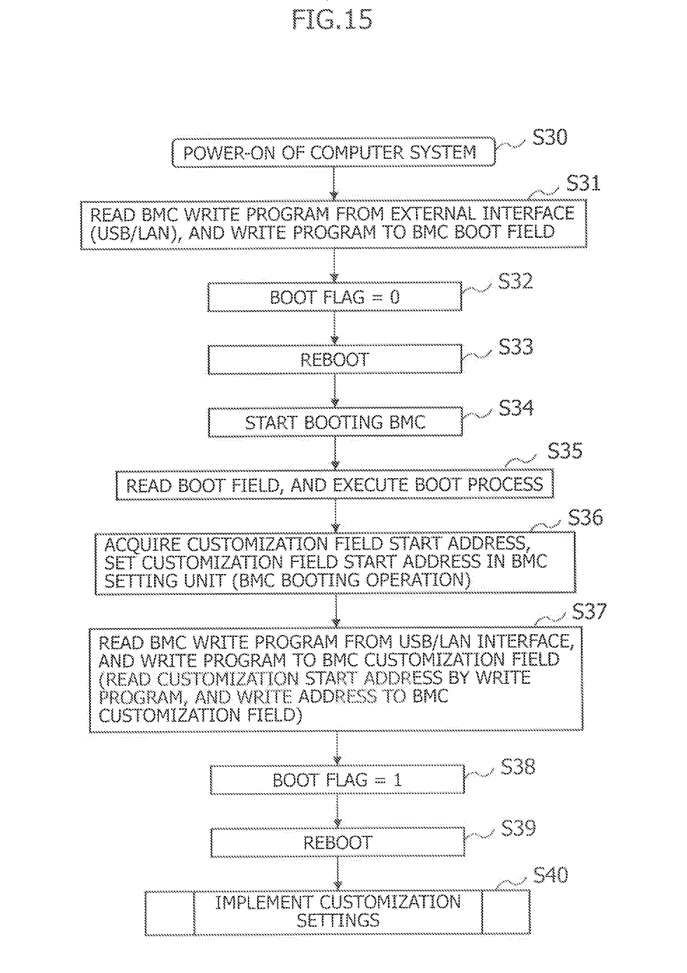

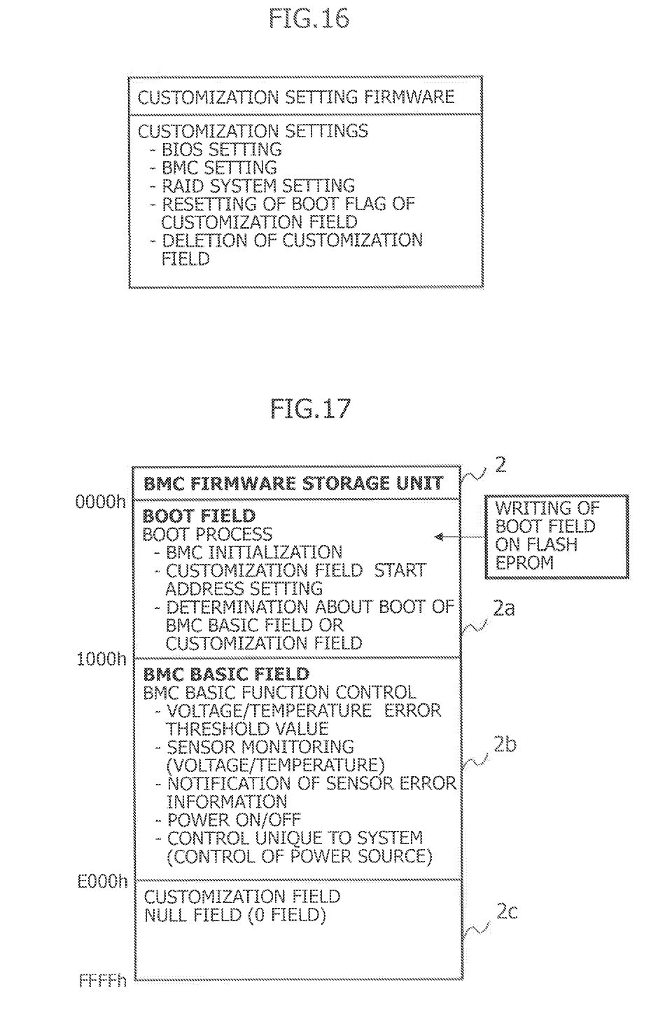

FIGS. 15-20 are an explanatory flowchart and explanatory diagrams of a processing flow in the second embodiment. FIG. 15 is one example of a flowchart of writing processes to the boot field 2a and the customization field 2c. FIGS. 16-20 illustrate the BMC firmware storage unit 2 and the BMC setting table 3 to be changed corresponding to the processes in the flowchart of FIG. 15.

FIG. 16 is a diagram illustrating one example of customization setting firmware. The customization setting firmware is developed and evaluated before starting the processes in FIG. 15. The customization setting firmware in FIG. 16 includes, e.g., a BIOS setting process, a BMC setting process, a RAID system setting process, a process of resetting the customization field boot flag, and a process of deleting the customization field. Herein, the customization setting firmware illustrated in FIG. 16 describes the processes contained in the customization setting firmware, but it does not mean that these processes are described in the execution format of the BMC processor 12.

A start of the processes in FIG. 15 is triggered by switching ON the power source of the information processing apparatus 1 (the computer system) in S30 after the customization setting firmware has been developed and evaluated.

The BMC processor 12 writes the firmware for executing a boot process to the BMC boot field 2a in S31. The firmware for executing the boot process can be written to the BMC boot field 2a by reading a program for writing the firmware from the external interface 40 instanced by the USB or the LAN and other equivalent interfaces, and executing the readout program.

FIG. 17 is a diagram illustrating one example of the BMC firmware storage unit 2 after writing to the boot field. The boot field 2a and the BMC basic field 2b of the BMC firmware storage unit 2 in FIG. 17 are the same as in FIG. 8, and the descriptions thereof are therefore omitted. The firmware is not written to the customization field 2c of the BMC firmware storage unit 2 in FIG. 17, and hence the customization field 2c is a null field. Subsequently, the BMC processor 12 shifts the processing to S32.

The BMC processor 12 sets “0” in the boot flag of the customization setting field 3b in the BMC setting table 3 in S32, and shifts the processing to S33. The BMC processor 12 reboots the information processing apparatus 1 in S33, and shifts the processing to S34. The BMC processor 12 starts booting the BMC in S34, and shifts the processing to S35. The BMC processor 12 reads the boot field 2a and starts executing the boot process in S35, and shifts the processing to S36.

The BMC processor 12 acquires the customization field start address in S36. The BMC processor 12 may also acquire the last address of the BMC basic field 2b as the customization field start address. The BMC processor 12 sets the acquired address as the customization field start address of the customization setting field 3b in the BMC setting table 3. The BMC processor 12 executes the process in S36 through the acquiring unit 5.

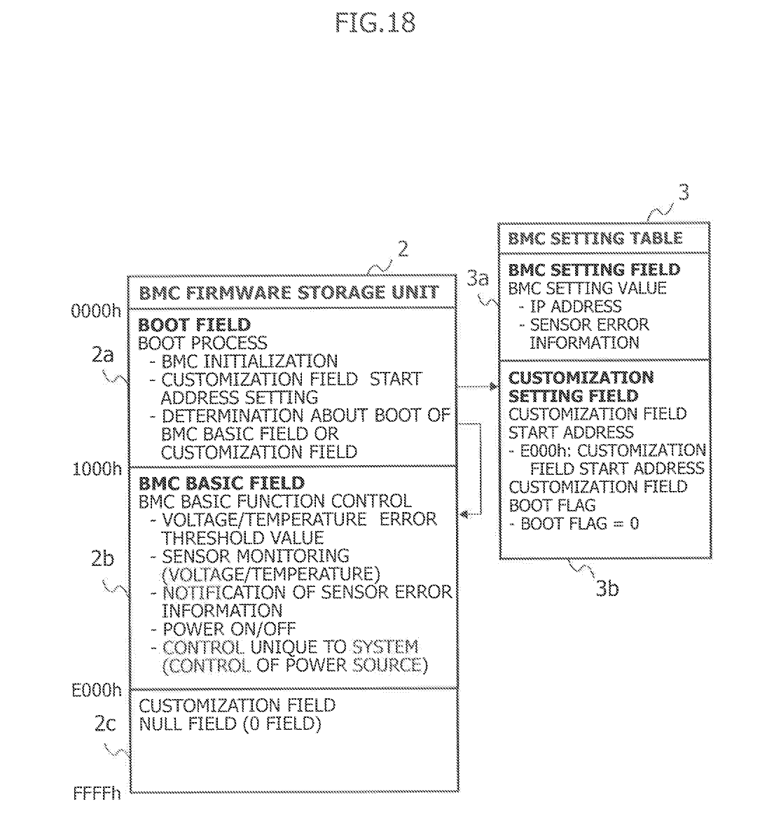

FIG. 18 is a diagram illustrating one example of the BMC firmware storage unit 2 and the BMC setting table 3 after executing the boot process. The BMC firmware storage unit 2 in FIG. 18 does not have any item changed from the BMC firmware storage unit 2 in FIG. 17, and therefore the description thereof is omitted. The BMC setting field 3a of the BMC setting table 3 is also the same as in FIG. 9, and hence its description is omitted.

The value “E000h” acquired in S36 is set as the customization field start address of the customization setting field 3b in FIG. 18. The value “0” is set in the boot flag in the process of S26. Subsequently, the BMC processor 12 shifts the processing to S37.

The BMC processor 12 writes the firmware for implementing the customization settings to the customization field 2c in S37. The firmware for implementing the customization settings can be written to the customization field 2c by reading a program for writing the firmware from the external interface 40 instanced by the USB or the LAN and other equivalent interfaces, and executing the readout program. The BMC processor 12 executes the process in S37 through the storage control unit 6.

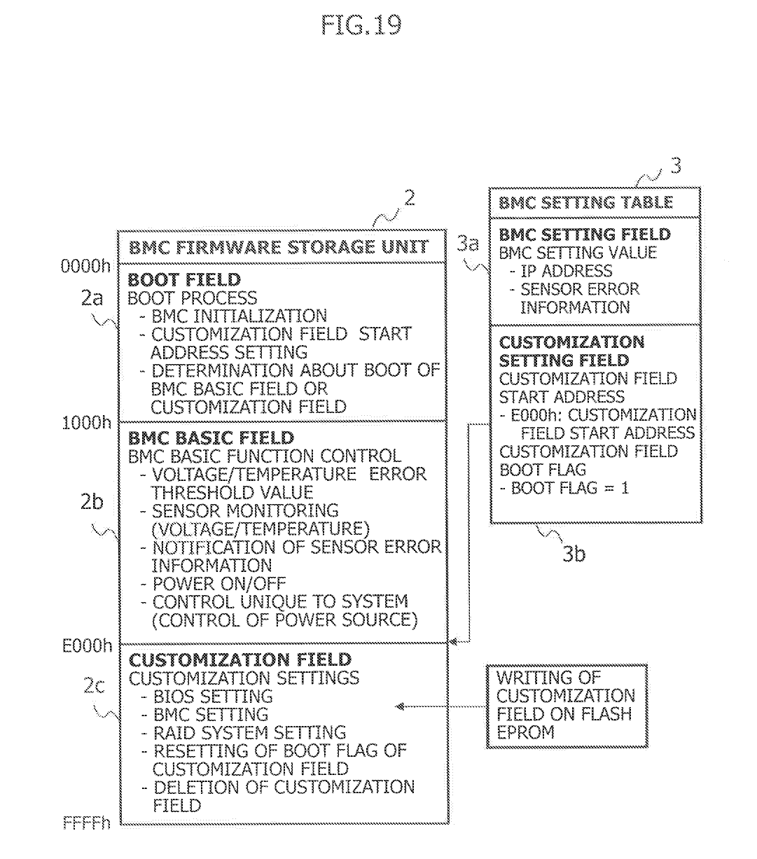

FIG. 19 is a diagram illustrating one example of the BMC firmware storage unit 2 and the BMC setting table 3 after writing to the customization field. The BMC firmware storage unit 2 in FIG. 19 is the same as in FIG. 8, and hence its description is omitted. The BMC setting table 3 in FIG. 19 does not have any item changed from the BMC setting table 3 in FIG. 18, and therefore the description thereof is omitted. Next, the BMC processor 12 shifts the processing to S38.

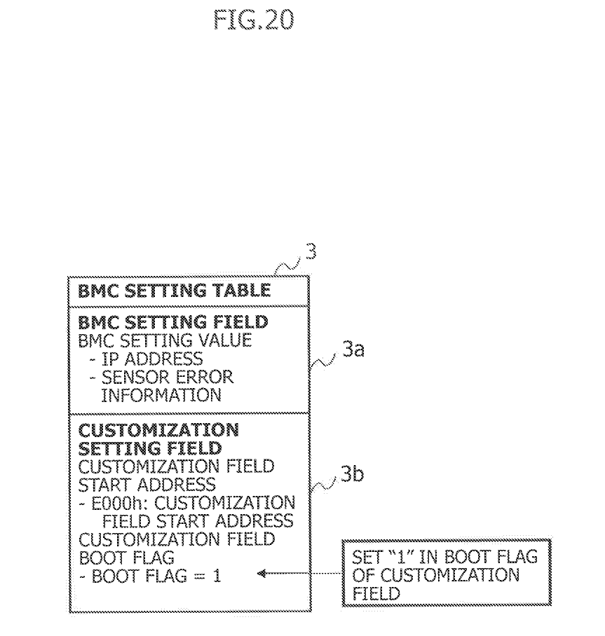

The BMC processor 12 sets “1” in the boot flag of the customization setting field 3b in the BMC setting table 3 in S38. FIG. 20 is the diagram illustrating one example of the BMC setting table 3 after writing to the customization field and updating the boot flag. The BMC setting field 3a of the BMC setting table 3 in FIG. 20 is the same as in FIG. 9, and therefore the description thereof is omitted. The value “E000h” is set as the customization field start address in the customization setting field 3b in FIG. 20. The value “1” is set in the boot flag. Subsequently, the BMC processor 12 shifts the processing to S39.

The BMC processor 12 reboots the information processing apparatus 1 in S39, and shifts the processing to S40. In S40, the BMC processor 12 implements the customization settings for the information processing apparatus 1 according to the flowchart depicted in FIG. 10.

<Operational Effect of Second Embodiment>

The information processing apparatus 1 in the second embodiment implements the customization settings after writing the customization field 2c in the storage location separated from the storage location of the BMC basic field 2b. The information processing apparatus 1 can write the firmware for implementing the customization settings to the customization field 2c by acquiring beforehand the storage location of the BMC basic field 2b without affecting the BMC basic field 2b. The customization settings can be therefore applied also to the active computer system.

The customization settings are individually developed without including the BMC basic function control. The information processing apparatus 1 writes the firmware including the processes of the individually developed customization settings to the customization field 2c separately from the BMC basic field 2b. In other words, it may be sufficient that the information processing apparatus 1 writes not the whole BMC firmware but the customization setting firmware to the customization field 2c. A period of time for writing the firmware can be thereby reduced.

<Others>

A program for making the computer execute any one of the processes in the embodiments discussed above, can be recorded on a computer readable storage medium. Then, the computer is made to read and execute the program on this recording medium, whereby the systems exemplified in the embodiments discussed above can be provided. Herein, the recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses.

The information processing apparatus, the setting method for the information processing apparatus, and the setting program for the information processing apparatus of the disclosure, enable the BMC firmware to easily and additionally implement the customization setting processes.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising: a control device,
the control device comprising:
a storage device including a first storage field to store a procedure for a control process of the information processing apparatus, and a second storage field to store a procedure for a setting process corresponding to a user of the information processing apparatus;
a memory storing a boot flag to specify whether the setting process is to be executed; and
a processor configured to set the boot flag so as to restrain the execution of the setting process after executing the setting process.

2. The information processing apparatus according to claim 1, wherein the storage device further comprises a third storage field to store a procedure for a boot control process to control booting the setting process.

3. The information processing apparatus according to claim 1, wherein the control device has control interfaces with a processor of the information processing apparatus and with peripheral devices in the information processing apparatus, and
the setting process contains settings via the control interfaces.

4. The information processing apparatus according to claim 1, wherein the processor of the control device further configured to:
acquire a storage location of the first storage field within the storage device;
store the storage location in the memory;
write the procedure for the setting process as the second storage field in a storage location separated from the storage location of the first storage field; and
set the boot flag so as to execute the setting process after the procedure of the setting process has been written.

5. A setting method for an information processing apparatus comprising a control device to execute the setting method, the setting method comprising:
executing a procedure for a control process of the information processing apparatus;
executing a procedure for a setting process corresponding to a user of the information processing apparatus;
determining a boot flag to specify whether the setting process is to be executed; and
setting the boot flag so as to restrain the execution of the setting process after executing the setting process.

6. A computer-readable recording medium having stored therein a program for causing a computer to execute a process for setting an information processing apparatus comprising a control device to execute the setting, the process comprising:
executing a procedure for a control process of the information processing apparatus;
executing a procedure for a setting process corresponding to a user of the information processing apparatus;
determining a boot flag to specify whether the setting process is to be executed; and
setting the boot flag so as to restrain the execution of the setting process after executing the setting process.
